(19) United States
(12) Patent Application Publication
(10) Pub. No.: US 2010/0212329 A1
(43) Pub. Date: Aug. 26, 2010

(54) BOIL-OFF GAS TREATMENT PROCESS AND SYSTEM

(75) Inventor: Paul Bridgwood, Woodlands (AU)

Correspondence Address: FITCH EVEN TABIN & FLANNERY, 120 SOUTH LASALLE STREET, SUITE 1600, CHICAGO, IL, 60603-3406, US

(73) Assignee: LNG Technology Pty Ltd, West Perth (AU)

(21) Appl. No.: 12/668,200

(22) PCT Filed: Jul. 9, 2008
(86) PCT No.: PCT/AU08/01011

§ 371 Date: Apr. 19, 2010

(30) Foreign Application Priority Data
Jul. 9, 2007 (AU) 2007903701

(51) Int. Cl. F17C 3/00

(52) U.S. Cl. 62/48.2

(57) ABSTRACT

A flowline system for transferring cryogenic liquids between a cryogenic liquid storage tank and a cryogenic liquid receiving/loading facility, and a method of maintaining the system at or marginally above cryogenic temperature during periods between transfer of cryogenic liquids between the cryogenic liquid storage tank and the cryogenic liquid receiving/loading facility are provided. The flowline system has a main transfer conduit and a vapour return line in fluid communication with the cryogenic liquid storage tank and the cryogenic liquid receiving/loading facility. A cooling medium line is provided that is in fluid communication with the main transfer conduit, the vapour return line, and a source of cooled boil-off gas, wherein the cooled boil-off gas is at or marginally above cryogenic temperature. The cooled boil-off gas is circulated between said tank and said facility through the main transfer conduit and the vapour return line during periods between transfer of cryogenic liquids to maintain the main transfer conduit and the vapour return line at or marginally above cryogenic temperature.

### FIELD

The present invention relates to a process and system for treating boil-off gas from a cryogenic liquid storage tank such as, for example, boil-off gas from LNG or NGL storage tanks.

### SUMMARY

Liquefaction of gases at cryogenic temperatures typically requires a source of refrigeration such as a propane-mixed refrigerant or cascade refrigerant plant. In particular, a closed loop single mixed refrigerant is particularly suitable for incorporation into a liquefaction plant for treatment of natural gas or coal seam gas (CSG). The inventors have recognised that increased LNG production and additional efficiencies in the liquefaction plant may be obtained by redirecting boil-off gases generated in low temperature storage tanks to the refrigeration plant and liquefying said gases to recover further liquefied methane and a gas fraction with a hydrocarbon composition more suitable for use as a fuel gas or regeneration gas to power various components within the liquefaction plant.

Accordingly, in a first aspect of the invention there is provided a process for treating boil-off gas generated in a cryogenic liquid storage tank comprising the steps of:
a) compressing the boil-off gas;
b) cooling the compressed boil-off gas in a manner to produce a liquid fraction and a cooled vapour fraction;
c) separating the liquid fraction and the cooled gaseous fraction; and
d) redirecting the liquid fraction to the cryogenic liquid storage tank.

In one embodiment of the invention, the boil-off gas is compressed to a pressure of about 3 bar to about 6 bar.

In one embodiment of the invention, the step of cooling the compressed boil-off gas comprises passing the compressed boil-off gas through a refrigeration zone. Preferably, the step of cooling the compressed boil-off gas comprises passing the compressed boil-off gas in counter current heat exchange with a mixed refrigerant.

In a preferred embodiment of the invention, the liquid fraction and the cooled vapour fraction are cooled to a temperature at or marginally above the temperature of the contents of the cryogenic liquid storage tank. In particular, the liquid fraction and the cooled vapour fraction are cooled to cryogenic temperature.

In another embodiment, the cooled vapour fraction is at least partially depleted of components comprised in the liquid fraction. In particular, the liquid fraction substantially comprises liquid methane with some nitrogen and the cooled vapour fraction comprises substantially nitrogen with some methane.

Advantageously, the process provides for the rejection of nitrogen from the liquid fraction, such that the concentration of nitrogen is increased in the vapour fraction relative to the liquid fraction.

In a further embodiment of the invention, the process further comprises compressing the cooled gaseous fraction to a pressure suitable for use as fuel gas and/or regeneration gas.

The cooled vapour fraction is compressed to a required fuel gas pressure. In a preferred embodiment of the invention, the cooled vapour fraction is used as a fuel gas to drive one or more compressors in the liquefaction plant.

In a second aspect of the invention there is a system for treating boil-off gas generated in a cryogenic liquid storage tank comprising:

a cryogenic liquid storage tank having a boil-off gas outlet and a liquid inlet;

a first compressor having an outlet and an inlet in fluid communication with the boil-off gas outlet;

a refrigeration zone having an outlet and an inlet in fluid communication with the first compressor outlet, the refrigeration zone being arranged to cool a compressed gas and produce a liquid fraction and a cooled vapour fraction;

a separator having an inlet in fluid communication with the refrigeration zone outlet; and

a line in fluid communication with a liquid fraction outlet of the separator and the liquid inlet of the cryogenic liquid storage tank.

In a further embodiment, the system of the present invention further comprises:

a second compressor having an inlet in fluid communication with a cooled vapour fraction outlet of the separator; and

a line in fluid communication with an outlet of the second compressor and regeneration/fuel gas system.

Preferably, the first compressor is a low pressure compressor and the second compressor is a high pressure compressor.

In one embodiment of the invention the refrigeration zone is employed in a fluid material liquefaction plant. In a preferred embodiment, the refrigeration zone comprises a single mixed refrigerant plant.

### DESCRIPTION OF THE DRAWINGS

Preferred embodiments, incorporating all aspects of the invention, will now be described by way of example only with reference to the accompanying drawings, in which:

FIG. 1 is a schematic flow chart of a process for liquefying a fluid material, such as for example natural gas or CSG, wherein the flow chart also incorporates a process for treating boil-off gas from a cryogenic liquid storage tank in accordance with one embodiment of the present invention; and

FIG. 2 is a composite cooling and heating curve for the single mixed refrigerant and the fluid material.

### DETAILED DESCRIPTION OF PREFERRED EMBODIMENT

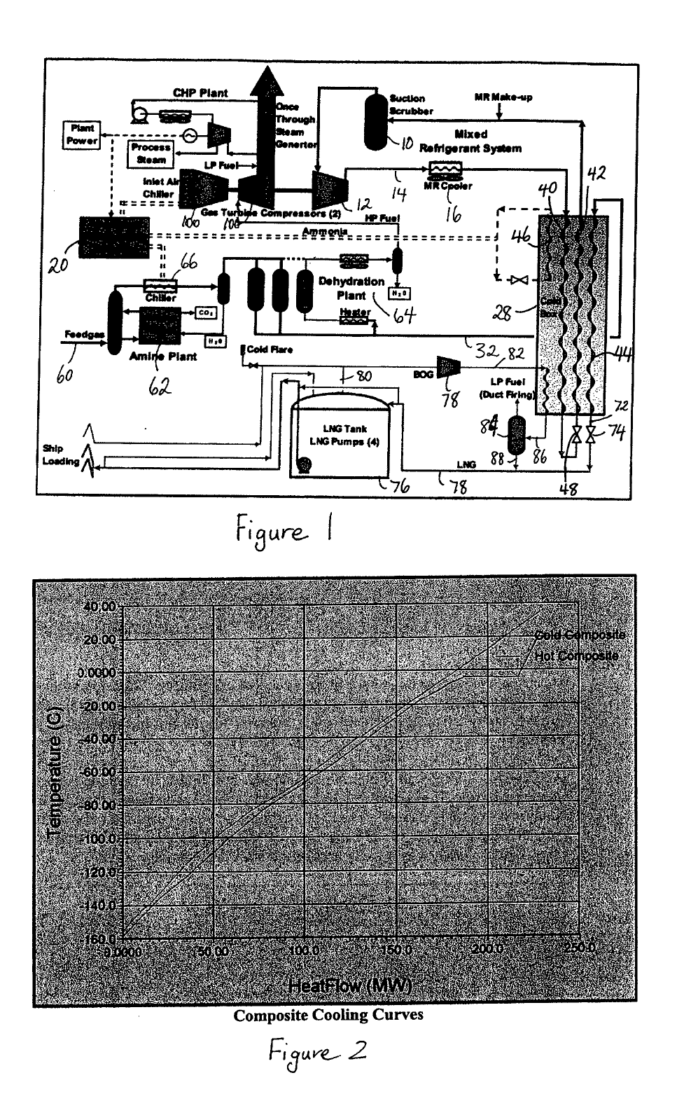

Referring to FIG. 1, there is shown a process for cooling a fluid material to cryogenic temperatures for the purposes of liquefaction thereof. Illustrative examples of a fluid material include, but are not limited to, natural gas and coal seam gas (CSG). While this specific embodiment of the invention is described in relation to the production of liquefied natural gas (LNG) from natural gas or CSG, it is envisaged that the process may be applied to other fluid materials which may be liquefied at cryogenic temperatures.

The production of LNG is broadly achieved by pre-treating a natural gas or CSG feed gas to remove water, carbon dioxide, and optionally other species which may solidify downstream at temperatures approaching liquefaction, and then cooling the pre-treated feed gas to cryogenic temperatures at which LNG is produced.

Referring to FIG. 1, the feed gas 60 enters the process at a controlled pressure of about 900 psi. Carbon dioxide is removed therefrom by passing it through a conventional packaged CO₂ stripping plant 62 where CO₂ is removed to about 50-150 ppm depending on the carbon dioxide concentration of the feed gas 10. Illustrative examples of a CO₂ stripping plant 62 include an amine package having an amine contactor (eg. MDEA) and an amine re-boiler. Typically, the gas exiting the amine contactor is saturated with water (eg. ˜70 lb/MMscf). In order to remove the bulk of the water, the gas is cooled to near its hydrate point (eg. ˜15° C.) using chilled water provided by a chiller 66. Preferably, the chiller 66 utilises cooling capacity from an auxiliary refrigeration system 20. Condensed water is removed from the cooled gas stream and returns to the amine package for make-up.

Water must be removed from the cooled gas stream to ≦1 ppm prior to liquefaction to avoid freezing when the temperature of the gas stream is reduced to below hydrate freezing point. Accordingly, the cooled gas stream with reduced water content (e.g. ˜20 lb/MMscf) is passed to a dehydration plant 64. The dehydration plant 64 comprises three molecular sieve vessels. Typically, two molecular sieve vessels will operate in adsorption mode while the third vessel is regenerated or in standby mode. A side stream of dry gas exiting the duty vessel is used for regeneration gas. Wet regeneration gas is cooled using air and condensed water is separated. The saturated gas stream is heated and used as fuel gas. Boil-off gas (BOG) is preferentially used as regeneration/fuel gas (as will be described later) and any shortfall is supplied from the dry gas stream. No recycle compressor is required for regeneration gas.

The feed gas 60 may optionally undergo further treatment to remove other sour species or the like, such as sulphur compounds, although it will be appreciated that many sulphur compounds may be removed concurrently with carbon dioxide in the CO₂ stripping plant 62.

As a result of pre-treatment, the feed gas 60 becomes heated to temperatures up to 50° C. In one embodiment of the present invention, the pre-treated feed gas may optionally be cooled with a chiller (not shown) to a temperature of about 10° C. to −50° C. Suitable examples of the chiller which may be employed in the process of the present invention include, but are not limited to, an ammonia absorption chiller, a lithium bromide absorption chiller, and the like, or the auxiliary refrigeration system 20.

Advantageously, depending on the composition of the feed gas, the chiller may condense heavy hydrocarbons in the pre-treated stream. These condensed components can either form an additional product stream, or may be used as a fuel gas in various parts of the system.

Cooling the pre-treated gas stream has the primary advantage of significantly reducing the cooling load required for liquefaction, in some instances by as much as 30% when compared with the prior art.

The cooled pre-treated gas stream is supplied to a refrigeration zone 28 through line 32 where said stream is liquefied.

The refrigeration zone 28 comprises a heat exchanger wherein refrigeration thereof is provided by a mixed refrigerant. Preferably, the heat exchanger comprises brazed aluminium plate fin exchanger cores enclosed in a purged steel box.

The refrigerated heat exchanger has a first heat exchange pathway 40 in fluid communication with the compressor 12, a second heat exchange pathway 42, and a third heat exchange pathway 44. Each of the first, second and third heat exchange pathways 40, 42, 44 extend through the refrigerated heat exchanger as shown in FIG. 1. The refrigerated heat exchanger is also provided with a fourth heat exchange pathway 46 which extends through a portion of the refrigerated heat exchanger, in particular a cold portion thereof. The second and fourth heat exchange 42, pathways are positioned in counter current heat exchange in relation to the first and third heat exchange pathways 40, 44.

Refrigeration is provided to the refrigeration zone 28 by circulating the mixed refrigerant therethrough. The mixed refrigerant from a refrigerant suction drum 10 is passed to a compressor 12. The compressor 12 is preferably two parallel single stage centrifugal compressors, each directly driven by gas turbines 100, in particular an aero-derivative gas turbine. Alternatively, the compressor 12 may be a two stage compressor with intercooler and interstage scrubber. Typically the compressor 12 is of a type which operates at an efficiency of about 75% to about 85%.

Waste heat from the gas turbines 100 may be used to generate steam which in turn is used to drive an electric generator (not shown). In this way, sufficient power may be generated to supply electricity to all the electrical components in the liquefaction plant.

Steam that is generated by waste heat from the gas turbines 100 may also be used to heat the amine re-boiler of the CO₂ stripping plant 62, for regeneration of the molecular sieves of the dehydration plant 64, regeneration gas and fuel gas.

The mixed refrigerant is compressed to a pressure ranging from about 30 bar to 50 bar and typically to a pressure of about 35 to about 40 bar. The temperature of the compressed mixed refrigerant rises as a consequence of compression in compressor 12 to a temperature ranging from about 120° C. to about 160° C. and typically to about 140° C.

The compressed mixed refrigerant is then passed through line 14 to a cooler 16 to reduce the temperature of the compressed mixed refrigerant to below 45° C. In one embodiment, the cooler 16 is an air-cooled fin tube heat exchanger, where the compressed mixed refrigerant is cooled by passing the compressed mixed refrigerant in counter current relationship with a fluid such as air, or the like. In an alternative embodiment, the cooler 16 is a shell and tube heat exchanger where the compressed mixed refrigerant is cooled by passing the compressed mixed refrigerant in counter current relationship with a fluid, such as water, or the like.

The cooled compressed mixed refrigerant is passed to the first heat exchange pathway 40 of the refrigeration zone 28 where it is further cooled and expanded via expander 48, preferably using a Joule-Thomson effect, thus providing cooling for the refrigeration zone 28 as a mixed refrigerant coolant. The mixed refrigerant coolant is passed through the second heat exchange pathway 42 where it is heated in countercurrent heat exchange with the compressed mixed refrigerant and the pre-treated feed gas passing through the first and third heat exchange pathways 40, 44, respectively. The mixed refrigerant gas is then returned to the refrigerant suction drum 10 before entering the compressor 12, thus completing a closed loop single mixed refrigerant process.

Mixed refrigerant make-up is provided from the fluid material or boil-off gas (methane and/or C2-C5 hydrocarbons), nitrogen generator (nitrogen) with any one or more of the refrigerant components being sourced externally.

The mixed refrigerant contains compounds selected from a group consisting of nitrogen and hydrocarbons containing from 1 to about 5 carbon atoms. When the fluid material to be cooled is natural gas or coal seam gas, a suitable composition for the mixed refrigerant is as follows in the following mole fraction percent ranges: nitrogen: about 5 to about 15; methane: about 25 to about 35; C2: about 33 to about 42; C3: 0 to about 10; C4: 0 to about 20 about; and C5: 0 to about 20. In a preferred embodiment, the mixed refrigerant comprises nitrogen, methane, ethane or ethylene, and isobutane and/or n-butane.

FIG. 2 shows a composite cooling and heating curve for the single mixed refrigerant and natural gas. The close proximity of the curves to within about 2° C. indicates the efficiencies of the process and system of the present invention.

Additional refrigeration may be provided to the refrigeration zone 28 by an auxiliary refrigeration system 20. The auxiliary refrigeration system 20 comprises one or more ammonia refrigeration packages cooled by air coolers. An auxiliary refrigerant, such as cool ammonia, passes through the fourth heat exchange pathway 44 located in a cold zone of the refrigeration zone 28. By this means, up to about 70% cooling capacity available from the auxiliary refrigeration system 20 may be directed to the refrigeration zone 28. The additional cooling has the effect of producing an additional 20% LNG and also improves plant efficiency, for example fuel consumption in gas turbine 100) by a separate 20%

The auxiliary refrigeration system 20 utilises waste heat generated from hot exhaust gases from the gas turbine 100 to generate the refrigerant for the auxiliary refrigeration system 20. It will be appreciated, however, that additional waste heat generated by other components in the liquefaction plant may also be utilised to regenerate the refrigerant for the auxiliary refrigeration system 20, such as may be available as waste heat from other compressors, prime movers used in power generation, hot flare gases, waste gases or liquids, solar power and the like.

The auxiliary refrigeration system 20 is also used to cool the air inlet for gas turbine 100. Importantly, cooling the gas turbine inlet air adds 15-25% to the plant production capacity as compressor output is roughly proportional to LNG output.

The liquefied gas is recovered from the refrigeration zone 28 through a line 72 at a temperature from about −150° C. to about −160° C. The liquefied gas is then expanded through expander 74 which consequently reduces the temperature of the liquefied gas to about −160° C. Suitable examples of expanders which may be used in the present invention include, but are not limited to, expansion valves, JT valves, venturi devices, and a rotating mechanical expander.

The liquefied gas is then directed to storage tank 76 via line 78.

Boil-off gases (BOG) generated in the storage tank 76 can be charged to a compressor 78, preferably a low pressure compressor, via line 80. The compressed BOG is supplied to the refrigeration zone 28 through line 82 and is passed through a portion of the refrigeration zone 28 where said compressed BOG is cooled to a temperature from about −150° C. to about −170° C.

At these temperatures, a portion of the BOG is condensed to a liquid phase. In particular, the liquid phase of the cooled BOG largely comprises methane. Although the vapour phase of cooled BOG also comprises methane, relative to the liquid phase there is an increase in the concentration of nitrogen therein, typically from about 20% to about 60%. The resultant composition of said vapour phase is suitable for use as a fuel gas.

The resultant two-phase mixture is passed to a separator 84 via line 86, whereupon the separated liquid phase is redirected back to the storage tank 76 via line 88.

The cooled gas phase separated in the separator 84 is passed to a compressor, preferably a high pressure compressor, and is used in the plant as a fuel gas and/or regeneration gas via line.

Alternatively, the cooled gas phase separated in the separator 84 is suitable for use as a cooling medium to circulate through a cryogenic flowline system for transfer of cryogenic fluids, such as for example LNG or liquid methane from coal seam gas, from a storage tank 76 to a receiving/loading facility, in order to maintain the flowline system at or marginally above cryogenic temperatures.

It is to be understood that, although prior art use and publications may be referred to herein, such reference does not constitute an admission that any of these form a part of the common general knowledge in the art, in Australia or any other country.

For the purposes of this specification it will be clearly understood that the word “comprising” means “including but not limited to”, and that the word “comprises” has a corresponding meaning.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

For example, while the specific embodiment of the invention described above is in relation to liquefaction of LNG from natural gas of coal seam gas, the present invention may be readily utilised in relation to other gases which are stored as liquids at cryogenic temperatures.

1. A process for treating boil-off gas generated in a cryogenic liquid storage tank comprising the steps of:
a) compressing the boil-off gas;
b) cooling the compressed boil-off gas in a manner to produce a liquid fraction and a cooled vapour fraction;
c) separating the liquid fraction and the cooled gaseous fraction; and
d) redirecting the liquid fraction to the cryogenic liquid storage tank.

2. The process according to claim 1, wherein the boil-off gas is compressed to a pressure of about 3 bar to about 6 bar.

3. The process according to claim 1 or claim 2, wherein the step of cooling the compressed boil-off gas comprises passing the compressed boil-off gas through a refrigeration zone.

4. The process according to claim 3, wherein the step of cooling the compressed boil-off gas comprises passing the compressed boil-off gas in counter current heat exchange with a mixed refrigerant.

5. The process according to claim 4, wherein the mixed refrigerant is a single mixed refrigerant.

6. The process according to any one of claims 1 to 5, wherein the liquid fraction and the cooled vapour fraction are cooled to a temperature at or marginally above the temperature of the contents of the cryogenic liquid storage tank.

7. The process according to claim 6, wherein the liquid fraction and the cooled vapour fraction are cooled to cryogenic temperature.

8. The process according to any one of claims 1 to 7, wherein the cooled vapour fraction is at least partially depleted of components comprised in the liquid fraction.

9. The process according to any one of claims 1 to 8, wherein the liquid fraction substantially comprises liquid methane.

10. The process according to any one of claims 1 to 9, wherein the concentration of nitrogen is increased in the vapour fraction relative to the liquid fraction.

11. The process according to any one of claims 1 to 10, wherein the cooled vapour fraction comprises at least 50% nitrogen.

12. The process according to any one of claims 1 to 11, wherein the process further comprises compressing the cooled vapour fraction to a pressure suitable for use as fuel gas and/or regeneration gas.

13. The process according to any one of claims 1 to 12, wherein the cooled vapour fraction is used as a fuel gas to drive one or more compressors in the liquefaction plant.

14. A system for treating boil-off gas generated in a cryogenic liquid storage tank comprising:
a cryogenic liquid storage tank having a boil-off gas outlet and a liquid inlet;
a first compressor having an outlet and an inlet in fluid communication with the boil-off gas outlet;
a refrigeration zone having an outlet and an inlet in fluid communication with the first compressor outlet, the refrigeration zone being arranged to cool a compressed gas and produce a liquid fraction and a cooled vapour fraction;
a separator having an inlet in fluid communication with the refrigeration zone outlet, a cooled vapour fraction outlet and a liquid fraction outlet; and
a line in fluid communication with a liquid fraction outlet of the separator and the liquid inlet of the cryogenic liquid storage tank.

15. The system according to claim 14, wherein the system further comprises:
a second compressor having an outlet and an inlet in fluid communication with the cooled vapour fraction outlet of the separator; and
a line in fluid communication with the outlet of the second compressor and a regeneration/fuel gas system.

16. The system according to claim 15, wherein the first compressor is a low pressure compressor and the second compressor is a high pressure compressor.

17. The system according to any one of claims 14 to 16, wherein the refrigeration zone is employed in a fluid material liquefaction plant.
